(19) United States
(12) Patent Application Publication
(10) Pub. No.: US 2026/0338913 A1
(43) Pub. Date: Oct. 29, 2026

(54) SYSTEM FOR ULTRA-WIDE BAND (UWB) RANGING AND/OR RADAR

(71) Applicant: Robert Bosch GmbH, Stuttgart (DE)

(72) Inventor: Matthew KELLY, Clayton (AU)

(21) Appl. No.: 19/703,334

(22) Filed: Jun. 10, 2026

Related U.S. Application Data
(63) Continuation-in-part of application No. PCT/EP2024/081532, filed on Nov. 7, 2024.

(30) Foreign Application Priority Data
Nov. 4, 2025 (DE) 10 2025 145 351.9

(51) Int. Cl. G01S 7/03; G01S 13/02; G01S 13/08

(52) U.S. Cl. CPC G01S 7/03; G01S 13/0209; G01S 13/08

(57) ABSTRACT

A system for Ultra-Wide Band (UWB) ranging and/or RADAR. The system includes a circuit provided on a circuit board. The circuit includes: two receive antennas each capable of emitting a radiation pattern having an intended region of operation; a transmit antenna capable of emitting a radiation pattern having an intended region of operation; the receive antennas being positioned on the circuit board such that the radiation patterns of the receive antennas are emitted in opposite directions relative to each other; wherein the transmit antenna is positioned between the receive antennas such that the radiation pattern of the transmit antenna is approximately overlapping with the radiation pattern of the receive antennas; and the system further includes ground area separation provided between the transmit antenna and the receive antennas.

### CROSS REFERENCE

The present application is a continuation-in-part of International Patent Application PCT/EP2024/081532 filed on Nov. 7, 2024, and also claims the benefit under 35 U.S.C. § 119 of German Patent Application No. DE 10 2025 145 351.9 filed on Nov. 4, 2025. International Patent Application PCT/EP2024/081532 and German Patent Application No. DE 10 2025 145 351.9 are expressly incorporated herein by reference in their entireties.

### BACKGROUND INFORMATION

Ultra-Wide Band (UWB) ranging applications in an automotive environment for applications such as Passive Entry Passive Start (PEPS) are desirable. The main objective of an UWB ranging device is to provide a distance estimate between an initiator and a responder but it is also desirable for the system to be capable of RADAR (radio detection and ranging). A problem with providing these applications is achieving an antenna configuration capable of providing a high fidelity, undistorted signal for the entirety of the required operating region of the system, i.e., the Field of View (FoV).

It will be appreciated that the discussion of the background to the present disclosure is included to explain the context of the present disclosure. This is not to be taken as an admission that any of the material referred to is published, known or part of the common general knowledge.

### SUMMARY

According to a first aspect, the present disclosure provides a system for Ultra-Wide Band (UWB) ranging and/or RADAR, the system including a circuit provided on a circuit board, the circuit including: two receive antennas each capable of emitting a radiation pattern having an intended operating region/Field of View (FoV); one transmit antenna capable of emitting a radiation pattern having an intended region of operation; the receive antennas being positioned on the circuit board such that the radiation patterns of the receive antennas are emitted in opposite directions relative to each other; and wherein the transmit antenna is positioned between the receive antennas such that the radiation pattern of the transmit antenna is approximately overlapping with the radiation pattern of the receive antennas.

Advantageously, the use of multiple antennas (i.e. providing antenna diversity) in the proposed orientation alleviates limitations such as signal loss at certain points and distortion causing ranging errors in the operating region/Field of View (FoV). Advantageously, the arrangement of the present invention improves the communications link between a vehicle and a fob or mobile phone as well as providing a high-fidelity signal in the FoV-enabling accurate ranging (i.e. time of flight calculations) and further providing the necessary antenna isolation allowing the system to function as a RADAR, which can detect the presence of passengers in a vehicle.

The UWB antenna configuration of the present disclosure can be used seamlessly with a Bluetooth (including Bluetooth Low Energy (BLE)) system incorporating a Bluetooth antenna oriented in the manner proposed so its implementation does not impair the performance of the UWB system.

It will be appreciated that the antenna configuration may be a stand-alone antenna design with an interface to an external circuit board or may be part of an embedded circuit. The circuit board may take any suitable form such as a printed circuit board (PCB) or the like as the skilled person would appreciate.

The system further includes adequate ground area separation provided between the transmit antenna and the receive antennas whereby the receive antennas are preferably positioned on a different horizontal X axis plane to the transmit antenna. This is required in order to allow ground metal above the receive antennas thereby providing improved isolation between the antennas. Advantageously, the improved isolation provides improved RADAR functionality.

In an example embodiment, the receive antennas are not positioned in substantially the same horizontal X axis plane.

Preferably, the radiation pattern of the receive antennas are primarily emitted in opposite directions relative to each other and includes a leftmost direction and a rightmost direction.

Preferably, the transmit antenna is positioned approximately in-between the receive antennas.

Preferably, the receive antennas and the transmit antennas are wide-band antennas. The wide-band antennas may include circular, elliptical or rectangular monopole antennas or any other type of wide-band antennas.

The system may further include a further antenna in close proximity to the UWB antennas for use in a Bluetooth system. The one or more further antennas may be an inverted-F antenna or the like.

Preferably, the receive antennas and the transmit antennas are provided on receiver pins and transmitter pins provided on an UWB integrated circuit.

Alternatively, the receive antennas and the transmit antennas are provided on transceiver pins on an UWB integrated circuit.

In an example embodiment, the receive antennas and the transmit antennas are provided on a single pin, 2 pin or 4 or more pin UWB integrated circuit by a series of RF switchers and/or RF combiners/splitters. It will be appreciated that the antenna configuration may be a stand-alone antenna design with an interface to an external device.

According to a second aspect, the present disclosure provides a system for Ultra-Wide Band (UWB) ranging and/or RADAR, the system including a circuit provided on a circuit board, the circuit including: two transmit antennas each capable of emitting a radiation pattern having an intended operating region/Field of View (FoV); one receive antenna capable of emitting a radiation pattern having an intended region of operation; the transmit antennas being positioned on the circuit board such that the radiation patterns of the transmit antennas are emitted in opposite directions relative to each other; and wherein the receive antenna is positioned between the transmit antennas such that the radiation pattern of the receive antennas is approximately overlapping with the radiation pattern of the transmit antennas.

According to a third aspect, the present disclosure provides a system for Ultra-Wide Band (UWB) ranging and/or RADAR, the system including a circuit provided on a circuit board, the circuit board including: two receive antennas each capable of emitting a radiation pattern having an intended region of operation; one transmit antenna each capable of emitting a radiation pattern having an intended region of operation; the receive antennas and transmit antenna being oriented on the circuit board such that an isolation value between each of the receive antennas and transmit antenna is below −15 dB in the required frequency band(s) of operation.

According to a fourth aspect, the present disclosure provides a system for Ultra-Wide Band (UWB) ranging and/or RADAR, the system including a circuit provided on a circuit board, the circuit board including: two transmit antennas each capable of emitting a radiation pattern having an intended region of operation; one receive antenna each capable of emitting a radiation pattern having an intended region of operation; the transmit antennas and receive antenna being oriented on the circuit board such that an isolation value between each of the transmit antennas and the receive antenna is below −15 dB in the required frequency band(s) of operation.

According to a fifth aspect, the present disclosure provides a substantially as hereinbefore described with reference to the drawings.

A system of one or more of the first, second, third, fourth or fifth aspects is further provided, wherein there is provided two or more receive antennas and two or more transmit antennas.

### BRIEF DESCRIPTION OF THE DRAWINGS

FIG. 1 is a schematic diagram illustrating the antenna configuration design on a PCB according to an example system of the present disclosure.

FIG. 2 is a schematic diagram illustrating simplified radiation patterns associated with the antennas of FIG. 1.

FIGS. 3A-3D is a schematic diagram illustrating a vehicle where the system described with reference to FIG. 1 and FIG. 2 are provided in the vehicle.

FIG. 4 is a chart of Isolation (dB) vs Frequency illustrating the operating region/Field of View (FoV) of the antennas of FIG. 1.

### DETAILED DESCRIPTION OF EXAMPLE EMBODIMENTS

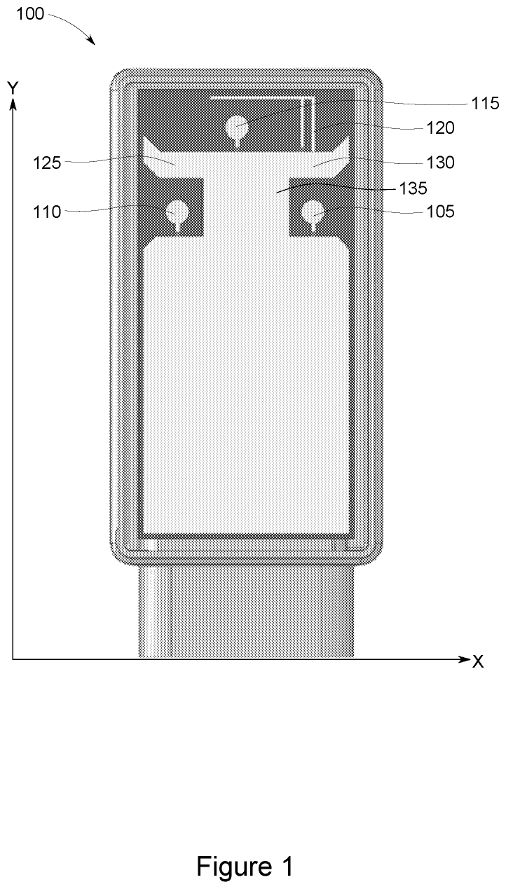

FIG. 1 is a schematic diagram illustrating a PCB design 100 using three UWB antennas 105, 110, 115 for an embedded circuit design utilizing an Ultra-Wide Band (UWB) Integrated Circuit (IC) with two receiver pins and one transmitter pin (IC not displayed in diagram). A Bluetooth antenna 120 may also be included for a system incorporating Bluetooth if required. For the purpose of describing the geometries of the PCB design 100 a coordinate system with an X-axis extending in horizontal direction and a Y-axis extending in vertical direction is included in FIG. 1. The Z-axis located orthogonally to X-and Y axis is not shown.

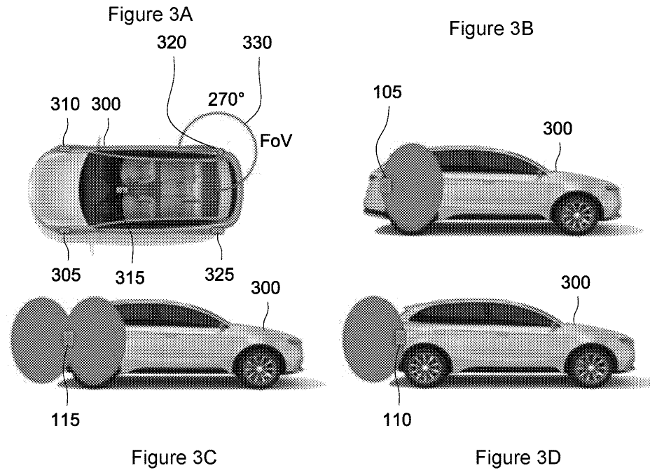

The PCB module 100 is preferably used as a transmitting/receiving unit for a motor vehicle shown in FIGS. 3A-3D. The installation position of the PCB module 100 could be oriented as shown in FIG. 1, the X-axis having the horizontal direction that reflects the orientation of the surface on which the vehicle is located. Alternatively, the PCB module 100 could also be installed rotated by 180° so that the transmitting antenna 115 is oriented downward to the X-axis instead of upward. This results in the sending or receiving fields for the antennas 105,110, 115 as shown in FIGS. 3A-3D.

According to FIG. 1 the transmitting antenna 115 is located at the top end of the PCB module 100. The two receiving antennas 110 and 105 are located below the transmitting antenna 115 on the left and right side area of the PCB module 100.

In order to meet the design criteria for an UWB and/or Radar System, a specific arrangement of antennas 105, 110, 115 is provided utilizing two receive antennas 105, 110 and one transmit antenna 115 on a PCB design 100.

It will also be appreciated that the reverse is also possible in that there may be two transmit antennas and one receive antenna by utilizing 105, 110 as the two transmit antennas and 115 as the receive antenna on a PCB design 100.

In addition, the antenna configuration can be a stand-alone antenna design with an interface to an external device.

In FIG. 1, the required three antennas are represented by antenna 105, 110, 115 which may be circular, elliptical or rectangular monopole antennas. It will be appreciated that any suitable wide-band antenna type may be used. A further antenna 120 is provided which may, be, for example, an inverted-F antenna for a Bluetooth system-that is to say that this antenna 120 is not part of the UWB system. In an embodiment, for the case where both UWB and Bluetooth systems are required, the present invention includes the option of providing a suitable location and orientation in the unutilized PCB area in close proximity to the UWB antenna 115 for a Bluetooth antenna without impairing the UWB performance. For ease of reference, the antennas 105, 110, 115 and 120 may be positioned with an offset along the Y axis and X axis relative to each other.

Preferably the two receive antennas 105, 110 are capable of emitting radiation patterns whereby the combination of the two radiation patterns cover the intended region of operation. Further, the transmit antenna 115 is also capable of emitting a radiation pattern having the same intended region of operation. As noted above it will be appreciated that the reverse may also be provided.

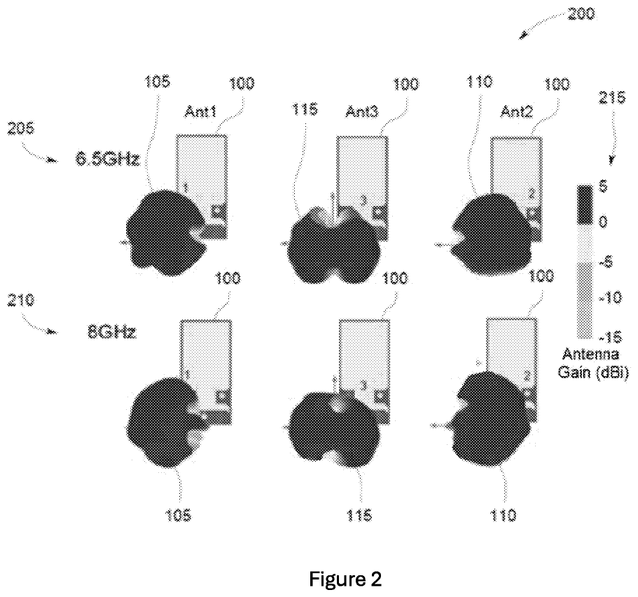

The receive antennas 105, 110 are positioned on the circuit board 100 such that the radiation patterns of the receive antennas 105, 110 are emitted in opposite directions relative to each other. Further, the transmit antenna 115 is preferably positioned approximately between the receive antennas 105, 110 along the X axis/horizontal plane, such that the radiation pattern of the transmit antenna 115 is approximately overlapping with the radiation pattern of the receive antennas 105, 110. This will be further described and shown with reference to FIG. 2. Further, in this embodiment, the transmit antenna 115 is also preferably positioned at a different location offset in the vertical direction Y.

It will be appreciated that respective antennas are positioned such that, for example: radiation patterns for both the transmit antennas 115 and receive antennas 105, 110 cover a required operating region/Field of View (FoV). Further, they are positioned such that there is isolation between all of the antennas such as to be below the requirement for RADAR performance—for example less than −15 dB in the required frequency band(s) of operation. Further, it is preferrable all of the antennas have a return loss greater than a minimum requirement—for example >7 dB in the required frequency band(s) of operation. Further, the antennas are designed such that the frequency of operation covers all UWB frequencies required in the system.

The system of the present invention meets the design criteria for an UWB ranging and/or RADAR system such that a specific arrangement of antennas utilizing two receive antennas 105, 110 and one transmit antenna 115 (or vice versa) on an PCB module 100 is provided. As will be appreciated, the arrangement and positioning of the UWB antennas and the adjacent PCB ground area must ensure that the above criteria are achieved simultaneously since all criteria are dependent on this positioning.

In one embodiment, two receive antennas 105, 110 are positioned such that their radiation patterns are emitted in opposite directions—for example one receive antenna 110 toward the leftmost direction and the other receive antenna 105 toward the rightmost direction. The two receive antennas 105, 110 are provided substantially in the same X axis/horizontal plane but this is not a requirement and they may be located on different horizontal planes. It will be appreciated that the receive antennas 105, 110 are placed on the same circuit board, but oriented to cover opposite hemispheres or the like. The transmit antenna 115 is positioned between the two receive antennas 105, 110 and for example, may or may not be equidistant from both receive antennas 105, 110. It will be appreciated that the transmit antenna 115 is preferably provided on a different horizontal plane than the receive antennas 105, 110 (for example, with reference to FIG. 1 antenna 115 is positioned offset in the vertical direction Y to the receive antennas 105, 110). This antenna placement advantageously allows the ground metal to be positioned in the Y-axis between and above the receive antennas 105, 110.

In an embodiment, as described above, the receive antennas 105, 110 may be non-coplanar in the X axis/horizontal plane, for example, one might be elevated or offset vertically. The placement of the antennas will be described further with reference to FIG. 2.

A metallic ground area separation region 125,130,135 is provided on the PCB module 100 to isolate the antennas 105,110,115 from one another. For example, sections of the ground area separation 125,130 for isolating the transmitting antenna 115 from the receiving antennas 105,110 run over the width of the PCB module 100 (along the X direction according to the coordinate system in FIG. 1). Likewise, the section of the ground area separation 125,130 in the Y direction between the transmitting antenna 115 and the two receiving antennas 105 and 110 (preferably at the same height according to the coordinate system in FIG. 1, the Y direction) is arranged to provide a suitable geometry for sufficient isolation. The ground area separation 125, 130 can be rectangular in shape. To optimize the isolation between the antennas 105,110, 115, preferably the end sections of the ground area separation 125,130, which are located at the side edges of the PCB module 100, can be inclined (as this is designed in the section in the direction of the receiving antennas 105 and 110 respectively) and/or in Y direction with increasing straight angle sections (as this is designed in the section in the direction of the transmitting antenna 115). In addition to straight slopes, rounded or other suitable geometries could also be provided.

The ground area separation 125 and 130 merge into a central area 135 of ground area separation. The middle area 135 of the ground area separation is arranged between the two receiving antennas 105 and 110. The middle area 135 is also located in the approximate middle of the PCB module 100 and is spaced apart from the receiving antennae 105 and 110 located further towards the side areas of the PCB.

The middle area 135 extends downward (with a shrinking Y coordinate) into a separation area that also surrounds the receiving antennae 105,110 in the Y direction and preferably extends up to the edge areas in X-direction of the PCB module 100. This lower area of the separation surface approximately extends over the entire width of the PCB module 100 up to the bottom of the PCB module 100.

The PCB module 100 can be constructed in multiple layers or with multiple PCBs. These multiple layers or printed circuit boards extend in the Z direction (not shown in FIG. 1). Thus, the antennas 105,110,115,120 can each be positioned on one single of the, if necessary, several layers or circuit boards). As an example, one of the receiving antennae 105,110 and the transmitting antenna 115 could be arranged on the same layer or PCB, while the further receiving antenna 105,110 and/or the further antenna 120 may be arranged on a further layer or PCB. The additional layers are advantageous when connecting the antennas to their associated electronic circuitry and for the general functioning and interconnectivity of the electronic system.

The ground area separation 125,130,135 can be separated in several layers on the printed circuit boards. The ground area separation 125,130,135 on several layers or printed circuit board is contacted with one another in an electrically conductive manner, for example, ground vias, in particular with the ground connection of the PCB module 100.

FIG. 2 is a schematic diagram 200 illustrating simplified radiation patterns associated with the antennas of FIG. 1 at frequencies of 6.5 GHz (denoted 205) and 8 GHz (denoted 210) which are within the desired frequency bands of operation. As can be seen from FIG. 2, the placement of receive antennas 105 and 110 causes a left and right oriented radiation pattern respectively. The combined received radiation pattern of the two antennas 105, 110 is therefore in both the left and right directions. This advantageously constitutes the required operating region/Field of View (FoV) of the UWB system. In addition, the transmitter antenna 115 as can be seen in FIG. 2 is approximately centrally located. It achieves a radiation pattern in both the left and right directions i.e. in the required FoV of the UWB system.

The Bluetooth antenna 120 can be oriented in the manner shown in FIG. 1 without adversely disturbing the UWB radiation patterns for a system requiring both UWB and Bluetooth. In order to reduce the overall PCB area required by the UWB and BLE antennas, the BLE may be located in the same PCB area. The metal ground separation 130 between the transmit antenna 115 and the receive antennas 105, 110 (as shown in FIG. 2) advantageously allows positioning of a BLE antenna 120 in a manner that does not impact the UWB performance (metal ground separation 125 could also be used).

In FIG. 2 and 3A-3D, simplified radiation patterns of antenna gain (dBi) are presented. These simplified images are for demonstration purposes, i.e., the signal will continue to radiate beyond the represented images into the distance at dimensioning signal levels as the distance from the antenna increases as the skilled person would appreciate. It will also be appreciated that for complete UWB coverage around a vehicle (for example), several modules may be positioned in the vehicle in order for the required operating region/Field of View (FoV) to be satisfied. This will be shown further with reference to FIG. 3A-3D. In addition, operational areas both external and internal to the vehicle may be required.

FIGS. 3A-3D shows a vehicle 300 within which several modules, that is to say the system described with reference to FIG. 1 and FIG. 2 are provided in the vehicle. These include module 305 placed, for example in the front left panel of the vehicle, module 310 placed, for example in the front right panel of the vehicle, module 315 placed, for example in the centre console of the vehicle, module 320 placed, for example in the right rear panel of the vehicle and module 325, for example placed in the left rear panel of the vehicle.

It will be appreciated that depending on the application the positioning of the modules may be provided in any suitable form and in any number of modules depending on the application. The operating region/Field of View (FoV) for each of the modules is shown. For example, in relation to module 320 where there is shown a FoV 325 which extends to the exterior trunk area of the vehicle and the exterior area along one side of the vehicle. By superimposing the radiation pattern from, for example, FIG. 2, onto the vehicle 300, the radiation patterns for antenna 115 shown in FIG. 3C can be seen and the radiation patterns for antennas 105 and 110 (again with reference to FIG. 2) can also be seen. In short, by superimposing the radiation patterns, it can be seen that it covers the FoV for the vehicle. This is repeated for each of modules 305, 310, 315, 320 and 325 which provides coverage for the entire vehicle 300.

For each module 305, 310, 315, 320 and 325, the radiation patterns with the vehicle allow for left and right placement of the receive antennas 105, 110 causing left and right oriented radiation patterns respectively as shown in FIGS. 3B and 3D. The combined radiation pattern of the two antennas is therefore in both the left and right directions. This constitutes the required operating region/Field of View (FoV) of the UWB system. In addition, the approximately centrally located transmitter antenna 115 achieves a radiation pattern in both the left and right directions shown in FIG. 3C i.e. the required FoV of the UWB system.

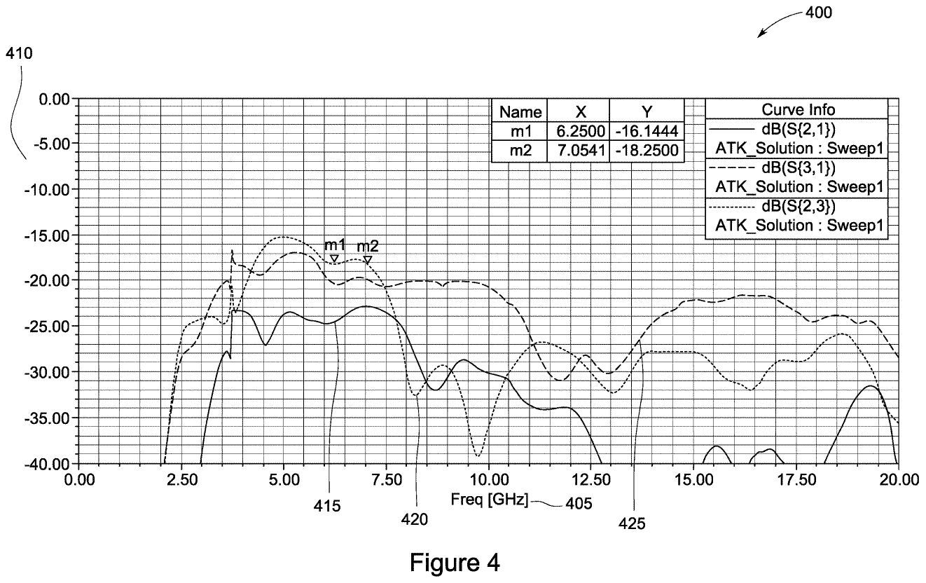

It will also be appreciated that, with reference to FIG. 1, ground area separations on the PCB 125 and 130 must be provided “above” (in the vertical direction Y) the receive antennas 105 and 110 and between transmit antenna 115 and receive antennas 105 and 110. These are critical for obtaining significant isolation between the antennas. This is shown in the chart 400 of FIG. 4 in which plots of dB of antenna 110 and antenna 105 (S2, 1) as well as antennas 115 and 105 (S3, 1) and antennas 110 and 115 (S2, 3). The free ends of the ground area separations 125, 130 may extend with an angled shaped end portion compared to the horizontal orientation of the otherwise horizontal shaped ground separation 125 in order in improve isolation between the antennas.

In an embodiment, the ground area separation surrounding receive antennas 105 and 110 may be shaped in a U-configuration or any other configuration that allows the ground metal to extend along the lateral and rear sides of each antenna as shown in 125 and 130. Advantageously, this structure improves isolation from the centrally located transmit antenna 115. The middle section 135 of the ground separation between antennas 105 and 110 is broadened, forming a wider grounded region that further reduces coupling.

As will be seen from FIG. 4, all plots are below the −15 dB isolation requirement between the required bandwidth in an operating frequency of approximately 6 to 10 GHz. The ground separation 125 and 130 and the orientation of the three UWB antennas 105, 105 and 115 is unique and critical to achieving this design criteria. This ground antenna arrangement is unique in providing the design criteria and is reached over a significant bandwidth.

It will be appreciated by the skilled person that additional antennas may be used. It will also be appreciated by the skilled person that the transmit and receive antennas are interchangeable. Further, a Bluetooth antenna may be added without impacting on UWB performance as shown in FIG. 1. It will also be appreciated that the present invention may be used with other integrated circuit transmit and receive pin arrangements. Finally, it will be appreciated that a transmit antenna can be used with a ground inlay to improve omni-directional radiation pattern performance.

What is claimed is:

1. A system for Ultra-Wide Band (UWB) ranging and/or RADAR, the system comprising a circuit provided on a circuit board, the circuit including:
two receive antennas each capable of emitting a radiation pattern having an intended region of operation; and
a transmit antenna capable of emitting a radiation pattern having an intended region of operation;
wherein the receive antennas are positioned on the circuit board such that the radiation patterns of the receive antennas are emitted in opposite directions relative to each other;
wherein the transmit antenna is positioned between the receive antennas such that the radiation pattern of the transmit antenna is approximately overlapping with the radiation patterns of the receive antennas; and
wherein the system further comprises a ground area separation provided between the transmit antenna and the receive antennas.

2. The system of claim 1, wherein the receive antennas are positioned on a different horizontal X axis plane to the transmit antenna to allow ground metal above the receive antennas thereby providing improved isolation between the receive antennas and the transmit antenna.

3. The system of claim 1, wherein the receive antennas are not positioned in the same horizontal X axis plane.

4. The system of claim 1, wherein the radiation patterns of the receive antennas emitted in opposite directions relative to each other includes a leftmost direction and a rightmost direction.

5. The system of claim 1, wherein the transmit antenna is positioned approximately in-between the receive antennas.

6. The system of claim 1, wherein the receive antennas and the transmit antenna are provided on receiver pins and transmitter pins provided on an UWB integrated circuit.

7. The system of claim 1, wherein the receive antennas and the transmit antenna are provided on transceiver pins on an UWB integrated circuit.

8. The system of claim 1, wherein the receive antennas and the transmit antenna are provided on a single pin, 2 pin, or 4 or more pin UWB integrated circuit by a series of at least one of RF switchers and/or RF combiners/splitters.

9. The system of claim 1, wherein the receive antennas and the transmit antenna are provided as a stand-alone antenna design with an interface to an external device.

10. The system of claim 1, wherein the receive antennas and the transmit antenna are wide-band antennas.

11. The system of claim 10, wherein the wide-band antennas include one of circular, elliptical, rectangular monopole antennas, or any other type of wide-band antenna.

12. The system of claim 1, wherein a further Bluetooth antenna is provided proximal to the receive antennas and the transmit antenna for use in a Bluetooth Low Energy (BLE) system.

13. A system for Ultra-Wide Band (UWB) ranging and/or RADAR, the system comprising a circuit provided on a circuit board, the circuit including:
two transmit antennas each capable of emitting a radiation pattern having an intended region of operation; and
a receive antenna capable of emitting a radiation pattern having an intended region of operation;
wherein the transmit antennas are positioned on the circuit board such that the radiation patterns of the transmit antennas are emitted in opposite directions relative to each other;
wherein the receive antenna is positioned between the transmit antennas such that the radiation pattern of the receive antenna is approximately overlapping with the radiation patterns of the transmit antennas; and
wherein the system further comprises a ground area separation provided between the transmit antennas and the receive antenna.

14. A system for Ultra-Wide Band (UWB) ranging and/or RADAR, the system comprising a circuit provided on a circuit board, the circuit board including:
two receive antennas each capable of emitting a radiation pattern having an intended region of operation; and
a transmit antenna capable of emitting a radiation pattern having an intended region of operation;
wherein the receive antennas and the transmit antenna are oriented on the circuit board such that an isolation value between each of the receive antennas and the transmit antenna is below −15 dB in at least one required frequency band of operation.

15. A system for Ultra-Wide Band (UWB) ranging and/or RADAR, the system comprising a circuit provided on a circuit board, the circuit board including:
two transmit antennas each capable of emitting a radiation pattern having an intended region of operation; and
a receive antenna capable of emitting a radiation pattern having an intended region of operation;
wherein the transmit antennas and the receive antenna are oriented on the circuit board such that an isolation value between each of the transmit antennas and the receive antenna is below −15 dB in at least one required frequency band of operation.
